(19) United States
(12) Patent Application Publication
(10) Pub. No.: US 2020/0234596 A1
(43) Pub. Date: Jul. 23, 2020

(54) METHOD AND APPARATUS FOR HAPTICALLY GUIDING A USER

(71) Applicant: GM Global Technology Operations LLC, Detroit, MI (US)

(72) Inventors: Joseph F. Szczerba, Grand Blanc, MI (US); Carl W. Wellborn, Detroit, MI (US); Jim K. Rainbolt, Haslett, MI (US); Suzanne Spigelmyer, Sterling Heights, MI (US); Omer Tsimhoni, Bloomfield Hills, MI (US); Richard Zeldes, Ortonville, MI (US)

(73) Assignee: GM Global Technology Operations LLC, Detroit, MI (US)

(21) Appl. No.: 16/252,942

(22) Filed: Jan. 21, 2019

(51) Int. Cl. G08G 1/00; G08B 6/00; H04W 4/024; G01C 21/36

(52) U.S. Cl. CPC G08G 1/205; G01C 21/3652; H04W 4/024; G08B 6/00

(57) ABSTRACT

A guidance system for a user includes a first haptic device disposed on a first, rightward side and a second haptic device disposed on a second, leftward side of the user. A local controller is disposed on the user to communicate with the first and second haptic devices. A remote server is configured to communicate with the local controller. A vehicle includes a global positioning system sensor, and is in communication with the remote server. The local controller includes a control routine that is executable to determine a desired location of the vehicle, and determine a present location of the user. The control routine guides, via the first and second haptic devices, movement of the user towards the desired location of the vehicle, and indicates, via the first and second haptic devices, arrival of the vehicle at the desired location. The control routine pairs the user with the vehicle.

Physically challenged users often have difficulties accessing transportation in a manner that enables them to perform the action discretely, independently, and economically. Automated vehicles will offer a new option for this market segment, but a visual or speech centric user-interface may not be ideal for these travelers.

### SUMMARY

A guidance system for a user is described, and includes first and second haptic devices, wherein the first haptic device is disposed on a first, rightward side of the user and the second haptic device is disposed on a second, leftward side of the user. A local controller is disposed on the user and is configured to communicate with the first and second haptic devices. A remote server is configured to communicate with the local controller. A vehicle includes a sensor that is in communication with a global positioning system, and is in communication with the remote server. The local controller includes a control routine that is executable to determine a desired location of the vehicle, and determine, via the local controller, a present location of the user. The control routine guides, via the first and second haptic devices, movement of the user towards the desired location of the vehicle, and indicates, via the first and second haptic devices, arrival of the vehicle at the desired location. The control routine pairs the user with the vehicle.

An aspect of the disclosure includes a method for haptically communicating between a user and a vehicle that includes equipping the user with first and second haptic devices, wherein the first haptic device is disposed on a first, rightward side of the user and the second haptic device is disposed on a second, leftward side of the user, determining a desired geographical location of the vehicle, and determining a present geographical location of the user. The user is guided towards the desired geographical location of the vehicle via the first and second haptic devices, which also indicate arrival of the vehicle at the desired geographical location and pair the user with the vehicle.

Another aspect of the disclosure includes directing, via the first and second haptic devices, the user to enter the vehicle subsequent to pairing the user with the vehicle.

Another aspect of the disclosure includes controlling the vehicle to permit the user to enter the vehicle subsequent to pairing the user with the vehicle.

Another aspect of the disclosure includes directing the vehicle to proceed to a desired drop-off point.

Another aspect of the disclosure includes directing, via the first and second haptic devices, the user to exit the vehicle subsequent to arrival at the desired drop-off point.

Another aspect of the disclosure includes directing the user via the first and second haptic devices to exit the vehicle subsequent to arrival at the desired drop-off point including determining a side of the vehicle disposed towards a footpath, and directing the user via the first and second haptic devices to exit the vehicle on the side of the vehicle disposed towards the footpath subsequent to arrival at the desired drop-off point.

Another aspect of the disclosure includes guiding, via the first and second haptic devices, movement of the user towards a final destination via the first and second haptic devices subsequent to arrival at the desired drop-off point.

Another aspect of the disclosure includes controlling operation of the vehicle in response to communication from the user via the first and second haptic devices.

Another aspect of the disclosure includes discerning via the first and second haptic devices a desire by the user to proceed towards the desired drop-off point.

Another aspect of the disclosure includes discerning via the first and second haptic devices a desire by the user to stop the operation of the vehicle, and controlling operation of the vehicle to stop.

Another aspect of the disclosure includes discerning via the first and second haptic devices a desire by the user to stop the operation of the vehicle, and commanding the vehicle to stop.

Another aspect of the disclosure includes the first and second haptic devices being haptic devices that are disposed on respective first and second wristbands.

Another aspect of the disclosure includes the first and second haptic devices being haptic devices that are disposed on respective first and second earbuds.

Another aspect of the disclosure includes the first and second haptic devices being haptic devices that are disposed on an article of clothing.

As such, the disclosure sets forth a wearable user-interface that is capable of communicating with an autonomous vehicle, which may be employed by vision-impaired or hearing-impaired users to access a ride-sharing vehicle service. Wearable haptic devices operate as intuitive guidance devices to guide a user to a present or future location of a reserved vehicle, and also operate as communication devices to communicate with the vehicle before, during and after a trip.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a wearable haptic guidance system, vehicle and remote server that interact to haptically guide a user in relation to a vehicle, in accordance with the disclosure.

FIG. 2 schematically shows an embodiment of a guidance routine that enables a user to interact with a vehicle service routine located at a remote server to engage service from the vehicle, employing an embodiment of the haptic guidance system described with reference to FIG. 1, in accordance with the disclosure.

FIG. 3 schematically shows an example of a haptic guidance enablement routine in accordance with the disclosure.

FIG. 4 schematically shows an embodiment of a haptic guidance routine to guide a user to a destination, in accordance with the disclosure.

It should be understood that the appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

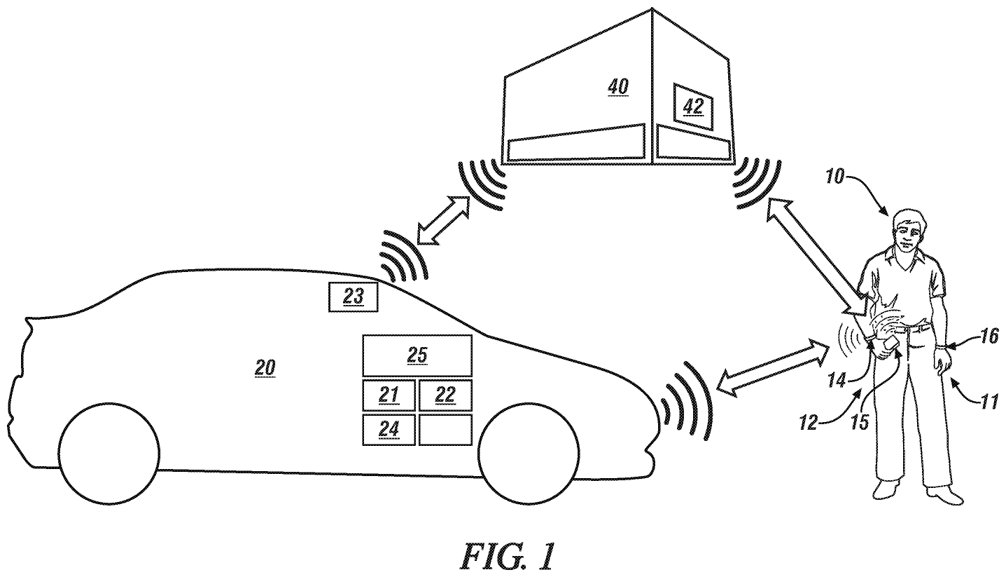

Referring to the drawings, wherein like reference numerals correspond to like or similar components throughout the several Figures, FIG. 1, consistent with embodiments disclosed herein, schematically illustrates a wearable haptic guidance system 12, vehicle 20 and remote server 40 that interact to haptically guide a user 10 in relation to a vehicle 20. The haptic guidance system 12 communicates with a vehicle service routine 42 that is located at the remote server 40, which is involved in enabling and facilitating use of the vehicle 20 by the user 10. The vehicle 20 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The haptic guidance system 12 includes a user-wearable haptic system 11 that includes, in one embodiment, first and second haptic devices 14, 16, respectively, and a local controller 15. The local controller 15 is disposed on the user 10 configured to wirelessly communicate with the first and second haptic devices 14, 16, the vehicle 20, and the remote server 40 using cellular, satellite or another wireless communication technology. The first and second haptic devices 14, 16 are, in one embodiment, mechatronic devices that mechanically vibrate in response to a command, thus providing localized tactile stimulation to the user 10 when worn. In one embodiment, the first haptic device 14 is disposed on a first, rightward side of the user 10 and the second haptic device 16 is disposed on a second, leftward side of the user 10. The first and second haptic devices 14, 16 may be disposed on wristbands, rings, an article of clothing, a belt, bows of eyeglasses, combinations thereof, earbuds, or at another location. Alternatively, the first and second haptic devices 14, 16 may be disposed on a carryable device, such as a leash or harness for a leader dog or another service animal, or a walking stick.

The local controller 15 is disposed on the user 10, and may be in the form of a cellular phone, or a stand-alone controller having wireless communication capability. The local controller 15 includes executable code in the form of a guidance routine 200, which enables the user 10 to interact with the vehicle service routine 42 to engage transportation service from the vehicle 20 and guide the user 10 to the vehicle 20 employing the haptic guidance system 12. The remote server 40 is configured to communicate with the local controller 15 as an element of the vehicle service routine 42.

The vehicle 20 includes a vehicle controller 21, a plurality of vehicle monitoring systems 22, an extra-vehicle communication device 23, a global positioning system (GPS) sensor 24, and, in one embodiment, an autonomous control system 25 that is configured to implement autonomous vehicle functionalities. Autonomous vehicle functionality may include an on-vehicle control system that is capable of providing a level of driving automation. The terms ‘driver’ and ‘operator’ describe the user responsible for directing operation of the vehicle 20, whether actively involved in controlling one or more vehicle functions or directing autonomous vehicle operation. Driving automation can include a range of dynamic driving and vehicle operations. Driving automation can include some level of automatic control or intervention related to a single vehicle function, such as steering, acceleration, and/or braking, with the driver continuously having overall control of the vehicle 20. Driving automation can include some level of automatic control or intervention related to simultaneous control of multiple vehicle functions, such as steering, acceleration, and/or braking, with the driver continuously having overall control of the vehicle 20. Driving automation can include simultaneous automatic control of vehicle driving functions that include steering, acceleration, and braking, wherein the driver cedes control of the vehicle for a period of time during a trip. Driving automation can include simultaneous automatic control of vehicle driving functions, including steering, acceleration, and braking, wherein the driver cedes control of the vehicle 20 for an entire trip, and is a passenger. Driving automation includes hardware and controllers configured to monitor the spatial environment under various driving modes to perform various driving tasks during dynamic vehicle operation. Driving automation can include, by way of non-limiting examples, cruise control, adaptive cruise control, lane-change warning, intervention and control, automatic parking, acceleration, braking, and the like. The autonomous vehicle functions include, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc.

The vehicle monitoring systems 22 include, by way of non-limiting example, the GPS sensor 24. The extra-vehicle communication devices 23 include, by way of non-limiting examples, devices and systems that are capable of vehicle-to-vehicle (V2V) communication, vehicle-to-infrastructure (V2I) communication, and vehicle-to-everything (V2X) communication, including to the remote server 40.

Communication between the first and second haptic devices 14, 16, the local controller 15, the vehicle 20 and the remote server 40 may be in the form of bi-directional wireless communication in one embodiment, including device-pairing of proximal devices. This includes bi-directional communication between the first and second haptic devices 14, 16 and the local controller 15, bi-directional communication between the first and second haptic devices 14, 16 and the vehicle 20, bi-directional communication between the local controller 15 and the vehicle 20, bi-directional communication between the vehicle 20 and the remote server 40, and bi-directional communication between the local controller 15 and the remote server 40.

The term “controller” and related terms such as control module, module, control, control unit, processor and similar terms refer to one or various combinations of Application Specific Integrated Circuit(s) (ASIC), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or another suitable communication link, and is indicated by line 25. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

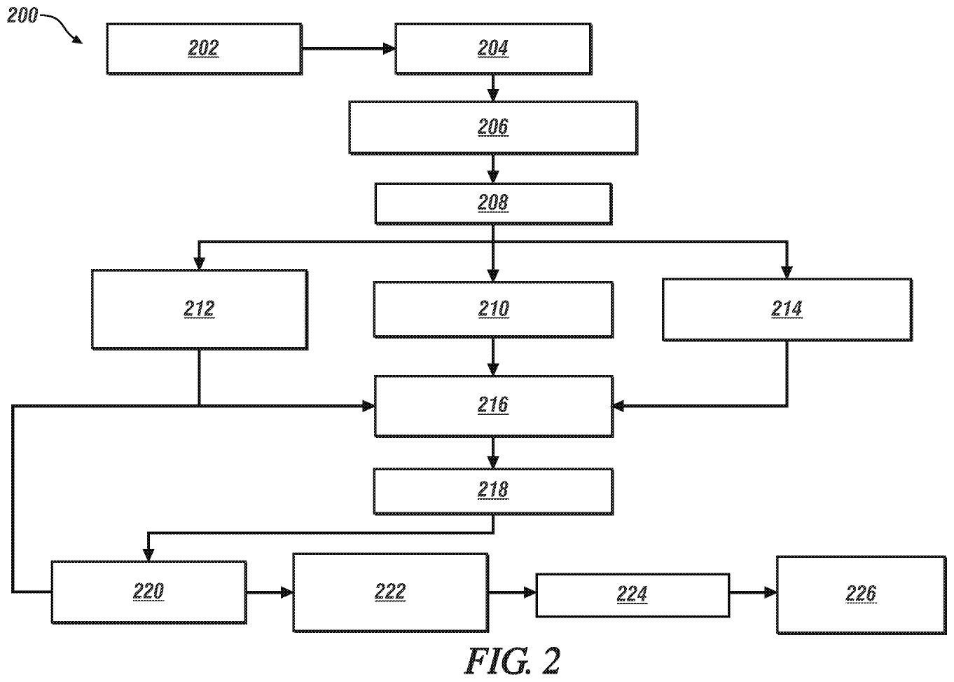

FIG. 2 schematically shows an embodiment of the guidance routine 200 that enables the user 10 to interact with the vehicle service routine 42 to engage service from the vehicle 20, employing an embodiment of the haptic guidance system 12 described with reference to FIG. 1. In one embodiment, the vehicle service routine 42 is in the form of executable code that is stored in a memory device that is located at the remote server 40. Table 1 is provided as a key wherein the numerically labeled blocks and the corresponding functions are set forth as follows, corresponding to the guidance routine 200. The teachings may be described herein in terms of functional and/or logical block components and/or various processing steps. It should be realized that such block components may be composed of hardware, software, and/or firmware components that have been configured to perform the specified functions.

TABLE 1

| BLOCK | BLOCK CONTENTS |
|---|---|
| 202 | User dons wearable haptic system and has |
| | local controller |
| 204 | User employs local controller to request |
| | vehicle service |
| 206 | Haptic guidance system guides user to |
| | vehicle |
| 208 | User is paired to vehicle |
| 210 | User commands operation of vehicle |
| 212 | Vehicle sensors monitor vehicle operating |
| | environment |
| 214 | Communication from outside the vehicle |
| 216 | Haptic communication to user during travel |
| 218 | User receives communication |
| 220 | User communicates to vehicle |
| 222 | Haptic communication to user indicating |
| | vehicle arrival at desired drop-off point |
| 224 | Haptic communication to user to disembark |
| | from vehicle and release vehicle |
| 226 | Haptic communication to guide user to final |
| | destination |

Execution of the guidance routine 200 may proceed as follows. The steps may be executed in a suitable order, and are not limited to the order described with reference to FIG. 2.

Operation of the guidance routine 200 begins with the user employing the local controller 15 to interact with the remote server 40 to engage the vehicle service routine 42 to obtain service from the vehicle 20, i.e., a ride request. The user 10 dons the wearable haptic system 11 and has the local controller 15 in their possession (202, 204). The vehicle service routine 42 identifies the vehicle 20 and determines a desired geographic location for the vehicle 20 that is proximal to and accessible by the user 10. Criteria for the desired geographic location being proximal to the user 10 include, by way of example, being within an acceptable walking distance along a navigable walking route. Criteria for the desired geographic location being accessible to the user 10 include, by way of example, a pick-up point that is in a pull-off area to enable safe ingress and egress from the vehicle 20 and lacking obstacles along the navigable walking route such as fences, railing, etc. When the user 10 employs the local controller 15 to interact with the remote server 40 to engage the vehicle service routine 42 to obtain service from the vehicle 20, a haptic guidance enablement routine 300 is initiated.

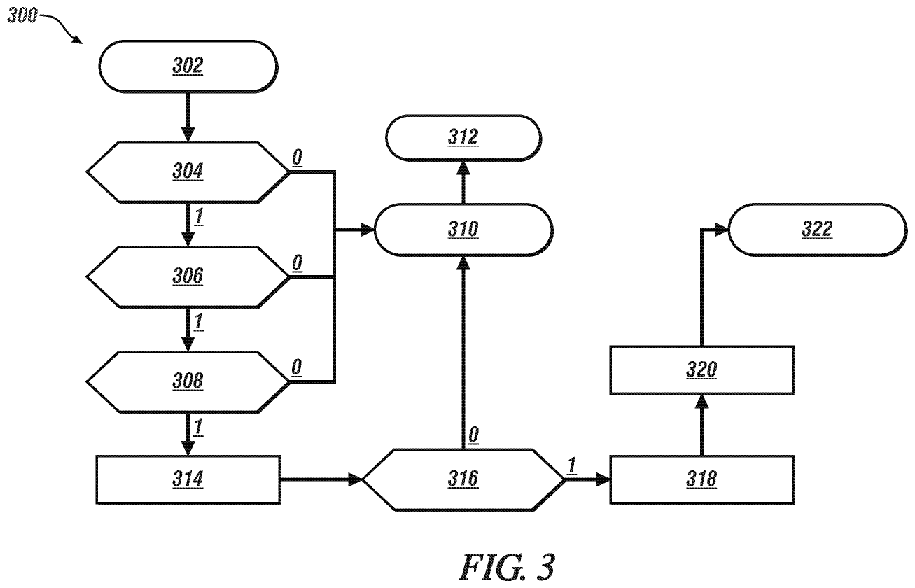

Referring now to FIG. 3, one example of the haptic guidance enablement routine 300 is shown, and is described as follows. As employed herein, the term “1” indicates an answer in the affirmative, or “YES”, and the term “0” indicates an answer in the negative, or “NO”. The remote server 40 sends a confirmation signal to the user 10 (302) to determine whether the local controller 15 has the capability of communicating with the wearable haptic system 11 to provide haptic guidance to the user 10 (304), whether a haptic guidance routine 400 has been enabled in the local controller 15 (306), and whether the wearable haptic system 11 has been enabled (308). If any of these criteria are not valid (304)(0), (306)(0), or (308)(0), the haptic guidance routine 400 is disabled (310), and this result is communicated to the user 10 (312).

When all of these criteria are valid (304)(1), (306)(1), and (308)(1), the haptic guidance routine 400 is enabled (314), and this result is communicated to the user 10 (314), which includes communicating to the user 10 that the vehicle 20 is within a predetermined range that indicates its readiness for connection (314). When the vehicle 20 is within the predetermined range of the user 10, and the local controller 15 is capable of communicating with the wearable haptic system 11 to provide haptic guidance to the user 10 (316)(1), the haptic guidance routine 400 is enabled (318) and executed (320) up to and including until the user 10 arrives at the vehicle 20 (322).

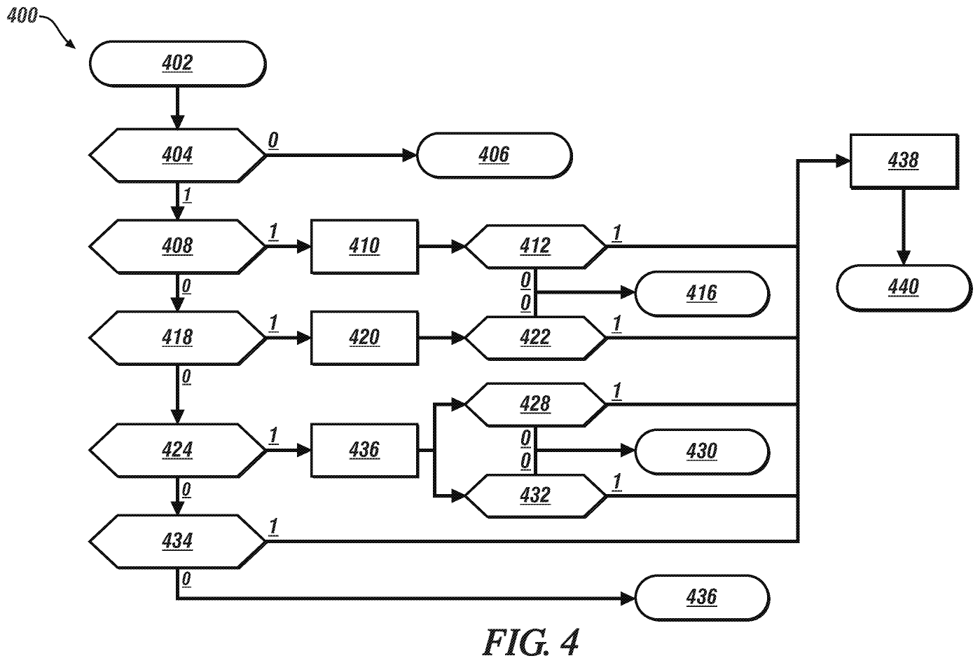

Referring again to FIG. 2, the guidance routine 200 guides the user 10 to the vehicle 20 employing a haptic guidance routine 400, which is described with reference to FIG. 4 (206).

FIG. 4 schematically shows details related to execution of an embodiment of the haptic guidance routine 400, which advantageously executes to guide the user 10 to a destination, e.g., to a pick-up point of the vehicle 20, or to another desired destination. As employed herein, the term “1” indicates an answer in the affirmative, or “YES”, and the term “0” indicates an answer in the negative, or “NO”. This includes providing turn-by-turn directions to guide the user 10 along the navigable walking route to reach the destination, e.g., the pick-up point of the vehicle 20. As appreciated, the navigable walking route can be divided into a plurality of segments, wherein each of the segments is a straight line on a navigable surface, and each junction of the segments includes an event requiring action on the part of the user 10, such as a leftward turn, a rightward turn, a curb, a set of steps, a crosswalk, etc.

Upon receiving a communication that the vehicle 20 is within a predetermined range that indicates its readiness for connection and thus enabling execution of the haptic guidance routine 400 (402), the local controller 15 monitors location of the user 10 to determine whether the user 10 has begun to traverse the navigable walking route towards the vehicle 20 (404). If there is no movement after a preset period of time (404)(0), the haptic guidance routine 400 disengages (406). The haptic guidance routine 400 may be re-engaged by an appropriate action by the user 10, such as by executing a double-tap on one of the first and second haptic devices 14, 16.

The local controller 15 monitors a trajectory of the user 10 in relation to a target, which may be the vehicle 20 or, alternatively, may be a junction associated with the segment of the navigable walking route. The trajectory of the user 10 and the target may be determined in context of a directional compass and associated compass bearings. When the trajectory of the user 10 is to the left of the target (408), the first haptic device 14 disposed on the rightward side of the user 10 is activated to vibrate (410), and thus urge the user 10 to veer to the right. When the user 10 veers to the right (412)(1), both the first and second haptic devices 14, 16 are activated (438), thus indicating to the user 10 that their trajectory is correct. When the user 10 does not veer to the right after a period of time (412)(0), the haptic guidance routine 400 disengages (416).

When the trajectory of the user 10 is to the right of the target (418), the second haptic device 16 disposed on the leftward side of the user 10 is activated to vibrate (420), and thus urge the user 10 to veer to the left. When the user 10 veers to the left (422), both the first and second haptic devices 14, 16 are activated (438), thus indicating to the user 10 that their trajectory is correct. When the user 10 does not veer to the left after a period of time (422)(0), the haptic guidance routine 400 disengages (416).

When the trajectory of the user 10 is opposite to the target (424), either the first haptic device 14 or the second haptic device 16 is activated to vibrate (426), and thus urge the user 10 to turn around. When the user 10 turns to the right (428) or to the left (432), both the first and second haptic devices 14, 16 are activated (438), thus indicating to the user 10 that their trajectory is correct. When the user 10 does not turn around after a period of time (428)(0), (432)(0), the haptic guidance routine 400 disengages (430).

When the trajectory of the user 10 is on-target (434)(1), both the first and second haptic devices 14, 16 are activated (438). When the trajectory of the user 10 is off-target (434)(0), the haptic guidance routine 400 disengages (436). When the user 10 arrives at the expected vehicle location, the haptic guidance routine 400 disengages (440), and operation of the guidance routine 200 continues.

Referring again to FIG. 2, when the user 10 has arrived at the vehicle location, the vehicle 20 is paired with the user 10 (208) in a manner that includes confirming identity of the user 10 to the vehicle 20, and confirming identity of the vehicle 20 to the user 10 via wireless communication. In one embodiment, this can include urging the user 10 to approach the vehicle 20, including grasping or otherwise touching a door handle or another portion of the vehicle 20. The vehicle controller 21 can communicate to the user 10 via the local controller 15 and the proximate one of the haptic devices 14, 16, and unlock an access panel, e.g., a vehicle door, thus allowing the user 10 to enter a passenger compartment of the vehicle 20.

When the user 10 has entered the vehicle 20, they are able to communicate with the vehicle controller 21 to command operation, including commanding the vehicle 20 to proceed to a desired drop-off point employing one or both of the haptic devices 14, 16 (210), (216) and (218). In one embodiment, this may be accomplished by having the user 10 tap one of the haptic devices 14, 16 twice in quick succession, with a confirmation message being sent by a command to pulse-activate the one of the haptic devices 14, 16. Operation of the vehicle 20 can then initiate to proceed to the desired drop-off point.

In a like manner, the vehicle monitoring systems 22 are able to monitor the vehicle operating environment and communicate information to the user 10, including alerting the user 10, employing one or both of the haptic devices 14, 16 (212). Furthermore, either the vehicle controller 21 or the local controller 15 may receive communication from the remote server 40, the Internet or a cloud computing environment (214).

During operation of the vehicle 20, there can be haptic communication between the user 10 and the vehicle controller 21 (220). One example of haptic communication between the user 10 and the vehicle controller 21 can include an urgent request to stop the vehicle 20. This may be accomplished by having the user 10 tap the haptic devices 14, 16 together three times in quick succession, with a confirmation message being sent to pulse-activate the one of the haptic devices 14, 16, followed by the vehicle controller 21 stopping the vehicle 20.

One example of haptic communication between the user 10 and the vehicle controller 21 can indicate to the user 10 that the vehicle 20 is approaching its desired drop-off point. This may be accomplished by having one of the haptic devices 14, 16 activated in a manner that indicates proximity to the desired drop-off point. In one embodiment, this may include executing a single buzz, e.g., for 1 second, when the vehicle 20 is within 5 minutes of arrival, executing a pair of buzzes, e.g., each for 1 second, when the vehicle 20 is within 3 minutes of arrival, executing three buzzes, e.g., each for 1 second, when the vehicle 20 is within 1 minute of arrival, and executing a single long buzz, e.g., for 5 seconds, when the vehicle 20 has arrived at the desired drop-off point.

When the vehicle 20 has arrived at the desired drop-off point and has stopped forward motion, the vehicle controller 21 can indicate to the user 10 that the ride is completed and that it is time to disembark from the vehicle 20 (222). This can include having one of the haptic devices 14, 16 activated in a manner that indicates a preferred side of the vehicle 20 for the user 10 to exit, such as having the first haptic device 14 activated to indicate to the user 10 to exit the vehicle 20 on the right side, or having the second haptic device 16 activated to indicate to the user 10 to exit the vehicle 20 on the left side, with an associated operations to unlock and open the respective vehicle access panel. The preferred side of the vehicle 20 for the user 10 to exit may include directing the user 10 via the first and second haptic devices 14, 16 to exit the vehicle 20 on the side of the vehicle 20 that is disposed towards a footpath, away from vehicle traffic, or otherwise provides an unobstructed vehicle exit path.

When the user 10 has exited the passenger compartment of the vehicle 20, the vehicle 20 may employ an in-vehicle camera or other device to determine if a personal article has been left behind. When a personal article has been left behind, the vehicle controller 21 can communicate with the local controller 15, which can haptically alert the user 10 via a rapid series of pulses, and then direct the user 10 to return to the vehicle 20 to retrieve the personal item.

When the user 10 has exited the passenger compartment of the vehicle 20, the user 10 can release the vehicle 20 from service (224). This can include some form of hand gesture, such as waving one of the haptic devices 14, 16 in an up-down motion. The vehicle controller 21 or the remote server 40 can confirm receipt of the haptic message via another haptic message, and proceed to another location.

When the user 10 has exited the passenger compartment of the vehicle 20, the routine 200 may continue to operate by guiding the user 10 to their final destination, again employing the haptic guidance routine 400 with the final destination being employed (226).

The concepts described thus provide a wearable haptic-based communication system to facilitate use of shared automated vehicle services by vision or hearing impaired users. This includes a control routine for tracking a user's dynamic location, and guidance to the target vehicle, which may also be in motion. Further provided is an integrated system, method, algorithm and mechanisms to enable haptic-based communication with movable and stationary targeted locations. In one embodiment, the system may be integrated with selected ride share applications and systems. Portions of the concepts may be deployed on another controller, e.g., a tablet, thus facilitating assistance by a caregiver, such as to summon vehicle service and to define a final destination. In one embodiment, the vehicle may be replaced by a tagged location, item, or person, and the system may be deployed to assist in guiding the user to the tagged location, item or person. As such the system can guide an individual to a targeted item or a location in physical space that is not plainly visible or may not be identifiable visually. The system may also be used in cacophonous environments wherein audible sound direction systems have reduced effectiveness, such as at a concert.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, the present disclosure may take the form of a computer program product embodied in a tangible medium of expression having computer-usable program code embodied in the medium. A combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in a combination of one or more programming languages.

Furthermore, portions of embodiments may also be implemented in cloud computing environments. In this description and the following claims, “cloud” and “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The remote server 40 includes a processing device, a communication device, and memory device that preferably includes a file including a store inventory. The processing device of the remote server 40 can include memory, e.g., read only memory (ROM) and random access memory (RAM), storing processor-executable instructions and one or more processors that execute the processor-executable instructions. In embodiments including two or more processors, the processors can operate in a parallel or distributed manner.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special-purpose hardware-based systems that perform the specified functions or acts, or combinations of special-purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for haptically communicating between a user and a vehicle, comprising:
equipping the user with first and second haptic devices, wherein the first haptic device is disposed on a first, rightward side of the user and the second haptic device is disposed on a second, leftward side of the user;
determining a desired geographical location of the vehicle;
determining a present geographical location of the user;
guiding, via the first and second haptic devices, movement of the user towards the desired geographical location of the vehicle;
indicating, via the first and second haptic devices, arrival of the vehicle at the desired geographical location; and
pairing the user with the vehicle.

2. The method of claim 1, further comprising directing, via the first and second haptic devices, the user to enter the vehicle subsequent to pairing the user with the vehicle.

3. The method of claim 1, further comprising controlling the vehicle to permit the user to enter the vehicle subsequent to pairing the user with the vehicle.

4. The method of claim 1, further comprising directing the vehicle to proceed to a desired drop-off point.

5. The method of claim 4, further comprising directing, via the first and second haptic devices, the user to exit the vehicle subsequent to arrival at the desired drop-off point.

6. The method of claim 5, wherein directing the user via the first and second haptic devices to exit the vehicle subsequent to arrival at the desired drop-off point comprises:
determining a side of the vehicle disposed towards a footpath, and
directing the user via the first and second haptic devices to exit the vehicle on the side of the vehicle disposed towards the footpath subsequent to arrival at the desired drop-off point.

7. The method of claim 5, further comprising guiding, via the first and second haptic devices, movement of the user towards a final destination via the first and second haptic devices subsequent to arrival at the desired drop-off point.

8. The method of claim 5, further comprising detecting presence of a personal article in the vehicle, haptically alerting the user based thereon, and directing the user to return to the vehicle to retrieve the personal article.

9. The method of claim 1, further comprising controlling operation of the vehicle in response to communication from the user via the first and second haptic devices.

10. The method of claim 9, further comprising discerning via the first and second haptic devices, a desire by the user to proceed towards a desired drop-off point.

11. The method of claim 9, further comprising discerning via the first and second haptic devices, a desire by the user to stop the operation of the vehicle, and controlling operation of the vehicle to stop.

12. The method of claim 9, further comprising discerning via the first and second haptic devices, a desire by the user to release the vehicle from service, and commanding the vehicle to depart.

13. The method of claim 1, further comprising discerning via the first and second haptic devices, a desire by the user to reserve the vehicle for service, and commanding the vehicle to proceed to the desired geographical location of the vehicle.

14. The method of claim 1, further comprising discerning via the first and second haptic devices, a desire by the user to reserve a vehicle from service, and commanding the vehicle to proceed to the desired geographical location of the vehicle.

15. A guidance system for a user, comprising:
first and second wearable haptic devices, wherein the first haptic device is disposed on a first, rightward side of the user and the second haptic device is disposed on a second, leftward side of the user;
a local controller disposed on the user and configured to communicate with the first and second wearable haptic devices;
a remote server configured to communicate with the local controller; and
a vehicle including a sensor in communication with a global positioning system, the vehicle in communication with the remote server;
the local controller including a control routine, the control routine executable to:
determine a desired geographical location of the vehicle;
determine, via the local controller, a present geographical location of the user;
guide, via the first and second wearable haptic devices, movement of the user towards the desired geographical location of the vehicle;
indicate, via the first and second wearable haptic devices, arrival of the vehicle at the desired geographical location; and
pair the user with the vehicle.

16. The guidance system of claim 15, wherein the local controller includes a geographic position location device configured to dynamically determine a present geographical location of the user.

17. The guidance system of claim 15, wherein the first and second wearable haptic devices comprise haptic devices that are disposed on respective first and second wristbands.

18. The guidance system of claim 15, wherein the first and second wearable haptic devices comprise haptic devices that are disposed on respective first and second wearable devices, wherein the wearable devices include a pair of earbuds, bows of eyeglasses, rings, or shoes.

19. The guidance system of claim 15, wherein the first and second wearable haptic devices comprise haptic devices that are disposed on an article of clothing.

20. A guidance system for a user, comprising:
first and second wearable haptic devices, wherein the first haptic device is disposed on a first, rightward side of the user and the second haptic device is disposed on a second, leftward side of the user;
a local controller disposed on the user and configured to communicate with the first and second haptic devices;
a remote server configured to communicate with the local controller; and
a remotely located device, configured to communicate with the remote server, and including a sensor in communication with a global positioning system;
the local controller including a control routine, the control routine executable to:
determine a geographical location of the remotely located device;
determine, via the local controller, a present geographical location of the user;
guide, via the first and second haptic devices, movement of the user towards the geographical location of the remotely located device; and
pair the user with the remotely located device.
